(19) United States
(12) Patent Application Publication
(10) Pub. No.: US 2025/0243569 A1
(43) Pub. Date: Jul. 31, 2025

(54) IRON-BASED RARE EARTH BORON-BASED ISOTROPIC NANOCOMPOSITE MAGNET ALLOY, METHOD FOR PRODUCING IRON-BASED EARTH BORON-BASED ISOTROPIC NANOCOMPOSITE MAGNET ALLOY, AND METHOD FOR PRODUCING RESIN-BONDED PERMANENT MAGNET

(71) Applicant: Murata Manufacturing Co., Ltd., Nagaokakyo-shi (JP)

(72) Inventors: Hirokazu KANEKIYO, Kyoto-shi (JP); Takashi YAMAZAKI, Nagaokakyo-shi (JP); Kazuhiro TAKAYAMA, Nagaokakyo-shi (JP)

(21) Appl. No.: 19/068,718

(22) Filed: Mar. 3, 2025

Related U.S. Application Data
(63) Continuation of application No. PCT/JP2023/023185, filed on Jun. 22, 2023.

(30) Foreign Application Priority Data
Sep. 14, 2022 (JP) 2022-146615

(51) Int. Cl. C22C 38/00; B22F 9/00; B22F 9/04; C22C 38/02; C22C 38/10; C22C 38/12; C22C 38/14; C22C 38/16; H01F 1/057; H01F 41/02

(52) U.S. Cl. CPC C22C 38/005; B22F 9/007; B22F 9/008; B22F 9/04; C22C 38/002; C22C 38/02; C22C 38/10; C22C 38/12; C22C 38/14; C22C 38/16; H01F 1/0578; H01F 41/0266; B22F 2301/355; B22F 2998/10; B22F 2999/00; C22C 2200/04; C22C 2202/02

(57) ABSTRACT

An iron-based rare earth boron-based isotropic nanocomposite magnet alloy including: an alloy composition having a formula T_{100-x-y-z}(B₁₋ₙCₙ)ₓRE_{y}Zr_{z}Mₘ where T includes Fe, RE includes at least Nd, M is at least one of Al, Si, V, Cr, Ti, Mn, Cu, Zn, Ga, Nb, Mo, Ag, Hf, Ta, W, Pt, Au, and Pb, 4.2 atom %≤x≤5.0 atom %, 12.5 atom %≤y≤14.0 atom %, 0 atom %<z≤2.0 atom %, 0.0 atom %≤m≤5.0 atom %, and 0.0≤n≤0.5; and the magnet alloy includes a main phase having a RE₂Fe₁₄B tetragonal compound with a B content concentration lower than a stoichiometric composition of the RE₂Fe₁₄B tetragonal compound, and a grain boundary phase comprising a phase richer in Fe than the main phase surrounding the main phase, and the tetragonal compound is finer than a critical single-domain diameter of an average crystal grain size of 10 nm to less than 70 nm.

### CROSS REFERENCE TO RELATED APPLICATIONS

The present application is a continuation of International application No. PCT/JP2023/023185, filed Jun. 22, 2023, which claims priority to Japanese Patent Application No. 2022-146615, filed Sep. 14, 2022, the entire contents of each of which are incorporated herein by reference.

### TECHNICAL FIELD

The present disclosure relates to an iron-based rare earth boron-based isotropic nanocomposite magnet alloy, a method for producing the iron-based rare earth boron-based isotropic nanocomposite magnet alloy, and a method for producing a resin-bonded permanent magnet.

### BACKGROUND ART

In recent years, there have been developed fine crystal isotropic magnets including hard magnetic phases such as Nd—Fe—B and Sm—Fe—N including fine crystal grains having an order size from nanometers to submicrometers, and nanocomposite isotropic magnets (hereinafter, referred to as a “nanocomposite magnet”) in which hard magnetic phases such as Nd—Fe—B and Sm—Fe—N including fine crystal grains and soft magnetic phases such as an Fe—B phase and an α-Fe phase are present in the same metal structure. These iron-based rare earth isotropic magnets including crystal grains having an order size from nanometers to submicrometers are fine crystal grains, and thus it has been revealed by computer simulation or the like applying micromagnetics that each crystal grain is magnetically bonded each other by exchange interaction in addition to static magnetic interaction to exhibit excellent magnet properties, achieving practical use as high-performance permanent magnet materials.

Conventionally, the fine crystal iron-based rare earth isotropic magnet has been utilized mainly in the electronic component industry as a representative for optical drives, spindle motors for hard disks, vibration motors (pager motors) for mobile phones, various sensors, and the like, as a resin binding magnet (common name: bonded magnet) obtained by pulverization to an average particle size of about 50 μm to 200 μm and then mixing with an epoxy resin-based thermosetting resin or a thermoplastic resin such as a nylon-based thermoplastic resin and polyphenylene sulfide (PPS) and a net shape magnet with a high degree of freedom in shape by taking advantage of the property of isotropy. In recent years, the high magnetic performance of fine crystal iron-based rare earth isotropic magnets has raised expectations for their development in applications such as brushless DC motors with outputs of approximately 1 horsepower (750 W) or less, used in automobiles (including electric and hybrid vehicles) and household appliances.

Particularly, in order to improve the performance and efficiency of a small motor of several hundred W class, a brushless DC motor using a bonded magnet using a conventional ferrite magnet has been shifting to a brushless DC motor using a bonded magnet, and a magnet material for a bonded magnet being more excellent in residual magnetic flux density Br, intrinsic coercive force HcJ, and maximum energy product (BH)max is required for a bonded magnet using a fine crystal iron-based rare earth isotropic magnet material that has been applied to a spindle motor, a vibration motor, and the like.

In order to meet this magnetic property requirement, it is necessary to increase the volume ratio of the ferromagnetic phase exhibiting hard magnetism or soft magnetism responsible for magnetic properties to the maximum and to minimize the volume ratio of the nonmagnetic phase forming the grain boundary of the hard magnetic phase. For example, in an iron-based rare earth boron-based isotropic magnet material, a RE₂Fe₁₄B (RE is a rare earth element) compound as a hard magnetic phase is used as a main phase, and a nonmagnetic grain boundary phase including boron surrounding the main phase is present, thereby adjusting magnetic interaction between main phase grains and providing development of an intrinsic coercive force HcJ of 700 kA/m or more applicable to various high-performance motors. In such a state, in order to increase the volume ratio of the RE₂Fe₁₄B compound as a hard magnetic phase, it is necessary to reduce the content ratio of boron, but if the content ratio of boron is excessively reduced, the residual magnetic flux density Br and the maximum energy product (BH)max are reduced due to the reduction in the squareness of the demagnetization curve. Therefore, there is no practical material with a content ratio of boron of 0.9% by mass or less, raising expectation of an iron-based rare earth boron-based isotropic magnet material capable of reducing the content concentration of boron and achieving excellent magnetic properties.

Particularly, in the iron-based rare earth boron-based isotropic magnet material applicable to various electric motors such as EV and HEV, in order to respond to customer requirements such as improvement in heat resistance and miniaturization of the motor, an intrinsic coercive force HcJ≥1200 kA/m that has been difficult to obtain with the iron-based rare earth boron-based isotropic magnet material has been required.

The isotropic magnet having, as a main phase, a Nd₂Fe₁₄B tetragonal compound including fine crystal grains expected to have high magnetic properties has, as a basic configuration, a stoichiometric composition of Nd:Fe:B=11.76:balance:5.88, but in order to achieve the intrinsic coercive force HcJ≥1200 kA/m applicable to various electric motors such as EV and HEV, it is necessary to increase the main phase ratio of RE₂Fe₁₄B, and to require Nd≥12.5 atom % having a RE concentration higher than that of the stoichiometric composition of RE₂Fe₁₄B. It is necessary to obtain the residual magnetic flux density Br≥0.8 T necessary for developing the magnet torque in the electric motor only by increasing the main phase ratio, but when Nd≥12.5 atom %, Fe and B become excess components in terms of alloy composition to lower the magnetization in the magnet alloy. Therefore, the maximum energy product (BH)max≥110 KJ/m³ having the squareness of the demagnetization polarity for obtaining a high magnet torque and for withstanding practical use cannot simultaneously expressed with HcJ≥1200 kA/m and Br≥0.81 T.

In addition, similarly, in the iron-based rare earth-based isotropic nanocomposite magnet alloy having the Nd₂Fe₁₄B tetragonal compound as a main phase, the Nd₂Fe₁₄B phase and the α-Fe phase or the Fe—B phase are mixed in the same metal structure with a crystal grain size on the order of nanometers, thereby causing behavior like an integrated magnet by exchange interaction acting between crystal grains, and thus providing excellent permanent magnet properties. However, the abundance ratio of the RE₂Fe₁₄B compound responsible for the intrinsic coercive force fails to be improved, and thus no RE-Fe—B-based isotropic permanent magnet material exhibiting sufficient magnetic properties has been found.

Patent Document 1 discloses an anisotropic sintered magnet having a RE₂Fe₁₄B tetragonal crystal structure as a main phase, and the magnet has a metal structure including RE₂Fe₁₄B tetragonal crystal grains on the order of micrometers, and is a magnet that exhibits favorable magnetic properties by magnetic orientation to align the magnetic moment in the C-axis direction of the RE₂Fe₁₄B tetragonal crystal, but favorable magnetic properties fail to be obtained as an isotropic magnet in which the magnetic moment is randomly arranged, resulting in impossible use as a practical magnet.

Patent Document 2 discloses an isotropic permanent magnet having, as a main phase, a hard magnetic phase having a RE₂Fe₁₄B tetragonal crystal structure including at least 10 atom % of a rare earth element, about 0.5 atom % to about 10 atom % of boron, and a balance iron, in which a high intrinsic coercive force HcJ of 1460 kA/m at the maximum is obtained, and the grain size of the RE₂Fe₁₄B crystal grains is 20 nm to 400 nm, including crystal grains exceeding the single domain crystal grain size of the RE₂Fe₁₄B crystal grains. As a result, in the example in which the magnetization decreases and the best magnetic properties are obtained, the residual magnetic flux density Br remains at a maximum of 0.83 T and the maximum energy product (BH)max remains at a maximum of 103 KJ/m³. Therefore, magnetic properties applicable to various electric motors such as EV and HEV are not achieved.

Patent Document 3 and Patent Document 4 disclose an iron-based rare earth-based isotropic nanocomposite magnet. These iron-based rare earth-based isotropic nanocomposite magnets mainly contain an α-Fe phase as a soft magnetic phase, and thus may provide a high residual magnetic flux density Br of 0.9 T or more, but are poor in the squareness of the demagnetization curve and are poor in the demagnetization resistance and heat resistance, and thus are not suitable as permanent magnet materials used for automobiles and household appliances.

On the other hand, Patent Document 5 discloses that in the iron-based rare earth-based isotropic nanocomposite magnet mainly containing an iron-based boride phase as a soft magnetic phase, adding Ti can suppress precipitation and growth of an α-Fe phase in a cooling process of a molten alloy, and can preferentially progress precipitation and growth of an Nd₂Fe₁₄B phase. However, Ti is easily bonded to the boron (B), and the TiB₂ phase is crystallized in the process of crystallization, thus causing a problem of decrease in the absolute amount of boron required for generating the Nd₂Fe₁₄B phase as the main phase, failing to provide the intrinsic coercive force HcJ expected from the content concentration of the rare earth element.

Patent Document 6 discloses an iron-based rare earth-based isotropic nanocomposite magnet mainly containing an iron-based boride phase as a soft magnetic phase, and teaches that adding Ti and carbon (C) can provide the following effects.

1. The liquidus temperature of the molten alloy decreases by 5° C. or more (for example, about 10° C. to about 40° C.). When the liquidus temperature of the molten alloy decreases by the addition of carbon, the crystallization of the coarse TiB₂ phase and the like is suppressed if the molten temperature is decreased accordingly, and thus the molten viscosity hardly increases. As a result, a stable molten metal flow can be continuously formed during the rapid cooling step of the molten alloy.

2. When the molten metal temperature decreases, sufficient cooling can be achieved on the surface of the cooling roll, and thus winding on the cooling roll can be prevented, and the rapidly solidified alloy structure can be uniformly refined.

3. The (B+C) concentration is high and the amorphous forming ability is high, and thus a fine metal structure is easily obtained if the molten metal cooling rate is set to a relatively low value of about 100° C./sec to 10,000° C./sec. Therefore, it is possible to prepare a rapidly solidified alloy including 60% or more of the Nd₂Fe₁₄B phase in a volume ratio without precipitating a coarse-Fe phase.

As described above, in the iron-based rare earth-based isotropic nanocomposite magnet requiring Ti addition as described in Patent Document 6, it is considered that excellent permanent magnet properties can be obtained because a hard magnetic phase having a uniform and fine Nd₂Fe₁₄B crystal structure and a soft magnetic phase including an Fe phase and an Fe—B phase coexist in the same metal structure. However, Ti, which is an essential element, is a nonmagnetic element, and in addition, does not enter the Nd₂Fe₁₄B phase, the Fe phase, and the Fe—B phase as a compound and is interspersed in the grain boundary, and as a result, the magnetization decreases, failing to achieve magnetic properties applicable to various electric motors such as EV and HEV.
Patent Document 1: Japanese Patent Application Laid-Open No. S59-46008
Patent Document 2: Japanese Patent Application Laid-Open No. S60-9852
Patent Document 3: Japanese Patent Application Laid-Open No. H8-162312
Patent Document 4: Japanese Patent Application Laid-Open No. H10-53844
Patent Document 5: Japanese Patent Application Laid-Open No. 2002-175908
Patent Document 6: Japanese Patent Application Laid-Open No. 2003-178908

### SUMMARY OF THE DISCLOSURE

In order to allow application to various electric motors such as EV and HEV, the intrinsic coercive force HcJ≥ 1200 kA/m is required, and in order to obtain the maximum energy product (BH)max≥110 KJ/m³ and the residual magnetic flux density Br≥0.81 T at which excellent squareness of demagnetization curves necessary for the minimum required magnet torque can be obtained, there is a problem that the size of crystal grains is refined to an average crystal grain size of 10 nm to less than 70 nm such that exchange interaction works effectively, and the interparticle interaction is adjusted to maximize the coercive force while suppressing nonmagnetic additive elements that do not form a compound, such as Ti, to the utmost.

In addition, the intrinsic coercive force HcJ and the residual magnetic flux density Br are in a trade-off relationship, and when the volume ratio of the main phase including the RE₂Fe₁₄B hard magnetic compound is increased in order to improve the intrinsic coercive force HcJ, the residual magnetic flux density Br decreases. Therefore, in order to suppress the decrease in the residual magnetic flux density Br, it is necessary to form the grain boundary phase adjacent to the main phase as a hard magnetic or semi-hard magnetic phase having high magnetization and a certain degree of anisotropic magnetic field in addition to the increase in exchange interaction acting between the grains due to the uniform and fine metal structure as described above.

The present inventors have considered that it is possible to obtain a permanent magnet material having excellent magnet properties that have not been conventionally obtained by setting the grain boundary phase, adjacent to the main phase, including the RE₂Fe₁₄B hard magnetic compound to hard magnetic or semi-hard magnetic, but it has been found that it is difficult to suppress the decrease in the residual magnetic flux density Br while maintaining the high intrinsic coercive force HcJ with the additive element such as Ti as described above.

The present disclosure has been made in view of the above circumstances, and a main object thereof is to secure magnet alloy properties required for application to various electric motors such as EV and HEV, and to provide an iron-based rare earth boron-based isotropic nanocomposite magnet alloy capable of improving residual magnetic flux density, intrinsic coercive force HcJ, and maximum energy product (BH)max with respect to an existing iron-based rare earth boron-based isotropic magnet alloy, a method for producing the iron-based rare earth boron-based isotropic nanocomposite magnet alloy, and a method for producing a resin-bonded permanent magnet including the iron-based rare earth boron-based isotropic nanocomposite magnet alloy.

The iron-based rare earth boron-based isotropic nanocomposite magnet alloy of the present disclosure has an alloy composition having a formula T_{100-x-y-z}(B₁₋ₙCₙ)ₓRE_{y}Zr_{z}Mₘ (where T is at least one element selected from Fe, Co, and Ni, and is a transition metal element including Fe, RE is at least one rare earth element including at least Nd among Nd and Pr, and M is at least one or more metal element selected from Al, Si, V, Cr, Ti, Mn, Cu, Zn, Ga, Nb, Mo, Ag, Hf, Ta, W, Pt, Au, and Pb, 4.2 atom %≤x≤5.0 atom %, 12.5 atom %≤y≤14.0 atom %, 0 atom %<z≤2.0 atom %, 0.0 atom %≤m≥5.0 atom %, and 0.0≤n≤0.5; and has a metal structure including a phase richer in Fe than a main phase, such as an Fe₁₇RE₂ phase or an α-Fe phase, in a grain boundary phase surrounding a main phase, in which the main phase is a RE₂Fe₁₄B tetragonal compound having a B content concentration lower than a stoichiometric composition of the RE₂Fe₁₄B tetragonal compound, the compound being finer than a critical single-domain diameter of an average crystal grain size of 10 nm to less than 70 nm.

In the iron-based rare earth boron-based isotropic nanocomposite magnet alloy, the width of the thickest portion of the grain boundary phase can be 1 nm to less than 150 nm. In addition, in the composition ratio between the main phase and the grain boundary phase, there can be provided the metal structure has a ratio of the main phase of 70% by volume to less than 99% by volume and a ratio of the grain boundary phase of 1% by volume to less than 30% by volume.

A method for producing an iron-based rare earth boron-based isotropic nanocomposite magnet alloy of the present disclosure includes: preparing a molten alloy having a composition represented by a composition formula T_{100-x-y-z}(B₁₋ₙCₙ)ₓRE_{y}Zr_{z}Mₘ (where T is at least one element selected from Fe, Co, and Ni, and is a transition metal element including Fe, RE is at least one rare earth element including at least Nd among Nd and Pr, and M is at least one or more metal elements selected from Al, Si, V, Cr, Ti, Mn, Cu, Zn, Ga, Nb, Mo, Ag, Hf, Ta, W, Pt, Au, and Pb), 4.2 atom %≤x≤5.0 atom %, 12.5 atom %≤y≤14.0 atom %, 0 atom %<z≤2.0 atom %, 0.0 atom %≤m≤5.0 atom %, and 0.0≤n≤0.5; and injecting the molten alloy onto a surface of a rotating roll mainly including Cu, Mo, W or an alloy containing at least one of these metals at an average molten metal outflow rate of 200 g/min to less than 2000 g/min per hole of an orifice disposed at a nozzle tip to form a rapidly solidified alloy having 1% by volume or more of either a crystal phase including a RE₂Fe₁₄B phase or an amorphous phase.

The method for producing the resin-bonded permanent magnet described above can include a step of preparing an iron-based rare earth boron-based isotropic nanocomposite magnet alloy powder produced by the method for producing the iron-based rare earth boron-based isotropic nanocomposite magnet alloy described above; and a step of adding a thermosetting resin to the iron-based rare earth boron-based isotropic nanocomposite magnet alloy powder to be filled into a mold, performing compression molding to form a compression molded body, and then performing a heat treatment at a temperature equal to or more than a polymerization temperature of the thermosetting resin.

The method for producing the resin-bonded permanent magnet described above can include a step of preparing an iron-based rare earth boron-based isotropic nanocomposite magnet alloy powder produced by the method for producing the iron-based rare earth boron-based isotropic nanocomposite magnet alloy described above; and a step of adding a thermoplastic resin to the iron-based rare earth boron-based isotropic nanocomposite magnet alloy powder to form an injection molding compound, and then performing injection molding.

The present disclosure can provide a rare earth boron-based isotropic nanocomposite magnet alloy capable of securing magnetic properties such as a residual magnetic flux density Br, an intrinsic coercive force HcJ, and a maximum energy product (BH)max required as a permanent magnet for various electric motors such as EV and HEV. In addition, the present disclosure can provide a method for producing the rare earth boron-based isotropic nanocomposite magnet alloy. Further, the present disclosure can provide a method for producing a resin-bonded permanent magnet including the rare-earth boron-based isotropic nanocomposite magnet alloy.

### BRIEF EXPLANATION OF THE DRAWINGS

FIG. 1 is a sectional view schematically showing an example of an iron-based rare earth boron-based isotropic magnet alloy of the present disclosure.

FIG. 2(a) is an apparatus configuration view of a heat treatment furnace for achieving flash annealing, and

FIG. 2(b) is a view showing a state of a rapidly solidified alloy moving in a furnace core tube.

FIG. 3 is a conceptual view of a thermal history by flash annealing performed in the present disclosure.

FIG. 4 is a powder X-ray diffraction profile of a rapidly solidified alloy obtained in Example 9.

FIG. 5 is a powder X-ray diffraction profile of a rapidly solidified alloy after flash annealing (crystallization heat treatment) obtained in Example 9.

FIG. 6 shows an element mapping image obtained in Example 24.

FIG. 7 is a powder X-ray diffraction profile of a rapidly solidified alloy after flash annealing (crystallization heat treatment) obtained in Comparative Example 7.

### DESCRIPTION OF THE PREFERRED EMBODIMENTS

Hereinafter, there will be described the rare earth boron-based isotropic nanocomposite magnet alloy of the present disclosure, a method for producing the rare earth boron-based isotropic nanocomposite magnet alloy of the present disclosure, a method for producing a powder including the rare earth boron-based isotropic nanocomposite magnet alloy of the present disclosure, and a method for producing the resin-bonded permanent magnet of the present disclosure. The present disclosure is not limited to a configuration below, and may be modified as appropriate without departing from the gist of the present disclosure. The present disclosure also includes a combination of a plurality of individual preferable configurations described below.

The rare earth boron-based isotropic nanocomposite magnet alloy of the present disclosure has an alloy composition having a formula T_{100-x-y-z}(B₁₋ₙCₙ)ₓRE_{y}Zr_{z}Mₘ (T is at least one element selected from Fe, Co, and Ni, and is a transition metal element including Fe, RE is at least one rare earth element including at least Nd among Nd and Pr, and M is at least one or more metal element selected from Al, Si, V, Cr, Ti, Mn, Cu, Zn, Ga, Nb, Mo, Ag, Hf, Ta, W, Pt, Au, and Pb), 4.2 atom %≤x≤5.0 atom %, 12.5 atom %≤y≤14.0 atom %, 0 atom %<z≤2.0 atom %, 0.0 atom %≤m≤5.0 atom %, and 0.0≤n≤0.5, and has a metal structure including a phase richer in Fe than the main phase, such as an Fe₁₇RE₂ phase or an α-Fe phase, in a grain boundary phase surrounding a main phase, in which the main phase is a RE₂Fe₁₄B tetragonal compound having a B content concentration lower than a stoichiometric composition of the RE₂Fe₁₄B tetragonal compound, the compound being finer than a critical single-domain diameter of an average crystal grain size of 10 nm to less than 70 nm.

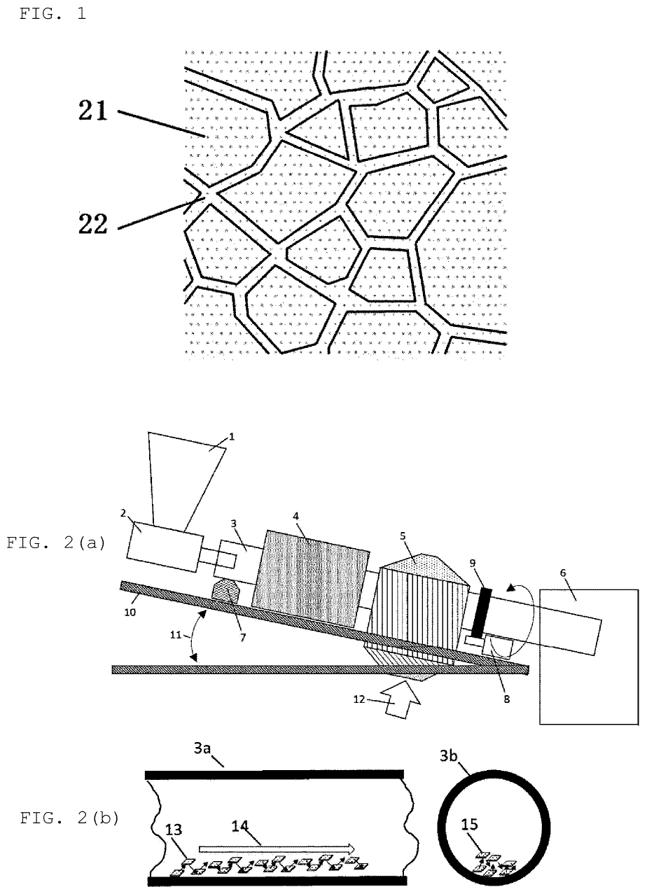

The width of the thickest portion of the grain boundary phase is preferably 1 nm to less than 150 nm. An example of such an iron-based rare earth boron-based isotropic magnet alloy of the present disclosure is shown in FIG. 1, showing a main phase 21 and a grain boundary 22.

The composition ratio between the main phase and the grain boundary phase is not necessarily limited, but the ratio of the main phase is preferably 70% by volume to less than 99% by volume, and the ratio of the grain boundary phase is preferably 1% by volume to less than 30% by volume.

The rare earth boron-based isotropic nanocomposite magnet alloy of the present disclosure is characterized by a low boron content concentration, and it is essential that the boron (B) content concentration in an alloy composition range in which a magnet alloy having a RE₂Fe₁₄B phase as a main phase is obtained is in a range of 4.2 atom % to less than 5.0 atom % lower than the stoichiometric composition of the RE₂Fe₁₄B tetragonal compound, and Zr is included in a range of 2.0 atom % or less. Further, in the rare earth boron-based isotropic nanocomposite magnet alloy of the present disclosure, the rare earth element (RE) and iron (Fe) are made into an excess state in the same alloy structure, thereby forming a grain boundary phase containing excess RE and Fe not required for generation of the RE₂Fe₁₄B phase as the main phase. As a result, the iron-based rare earth boron-based isotropic magnet alloy of the present disclosure can have, for example, a unique fine metal structure in which a grain boundary phase having a width of 1 nm to less than 70 nm exists in the thickest portion including a phase richer in Fe than the main phase, such as an Fe₁₇RE₂ phase or an α-Fe phase, surrounding an RE₂Fe₁₄B phase having an average crystal grain size of 10 nm to less than 150 nm.

The present inventors have found that the RE₂Fe₁₄B phase as the main phase and the grain boundary phase containing RE and Fe as main components, which are uniformly present around the main phase, are bound by a strong exchange interaction in addition to the static magnetic interaction by achieving a unique uniform and fine metal structure as described above, but strong binding of the exchange interaction (exchange coupling) decreases the intrinsic coercive force HcJ of the magnet alloy. However, it has been found that adjusting the formulation of RE-Fe—B and the concentration of Zr added forms a unique metal structure that becomes a grain boundary phase including a phase richer in Fe than the main phase, such as the Fe₁₇RE₂ phase or the α-Fe phase, thereby allowing to suppress the decrease in HcJ of the RE₂Fe₁₄B phase, and to provide a high maximum energy product (BH)max by improving the residual magnetic flux density Br applicable to various electric motors such as EV and HEV and the squareness of the demagnetization curve. Particularly, forming the metal structure configuration as described above is considered to provide high HcJ that cannot be achieved by the conventional rare earth iron-boron-based isotropic magnet without adding extremely rare and effective heavy rare earth elements such as Dy and Tb.

When the boron content concentration is less than 4.2 atom %, the production of the RE₂Fe₁₄B phase as the main phase is inhibited, and thus both the intrinsic coercive force HcJ and the residual magnetic flux density Br significantly decrease. In addition, when the boron content concentration is more than 5.0 atom %, a phase richer in Fe than the main phase, such as the Fe₁₇RE₂ phase or the α-Fe phase, does not precipitate in the grain boundary phase, and thus the residual magnetic flux density Br of 0.81 T or more can be achieved, but the intrinsic coercive force HcJ of 1200 kA/m or more fails to be obtained while maintaining the maximum energy product (BH)max of 110 KJ/m³ or more.

In contrast, when the boron content concentration is 4.2 atom % to 5.0 atom %, the grain boundary phase containing RE and Fe as main components and containing a phase richer in Fe than the main phase, such as the Fe₁₇RE₂ phase or the α-Fe phase, is uniformly generated without impairing the generation of the RE₂Fe₁₄B phase necessary for obtaining the intrinsic coercive force HcJ≥1200 kA/m or more, and thus the above magnetic properties are considered to be obtained.

Patent Document 2, Patent Document 3, Patent Document 4, Patent Document 5, and Patent Document 6 each disclose a microcrystalline isotropic permanent magnet material having a RE₂Fe₁₄B tetragonal compound contributing to an intrinsic coercive force HcJ, and the magnitude of the intrinsic coercive force HcJ mainly depends on the volume ratio of the RE₂Fe₁₄B tetragonal compound, and the intrinsic coercive force HcJ increases with increasing the volume ratio of the RE₂Fe₁₄B phase, and the intrinsic coercive force HcJ decreases with decreasing the volume ratio of the RE₂Fe₁₄B phase.

On the other hand, in the anisotropic RE₂Fe₁₄B sintered magnet described in Patent Document 1, heavy rare earth elements such as Dy and Tb are included in the RE₂Fe₁₄B tetragonal compound as the main phase, and increasing the anisotropic magnetic field of the RE₂Fe₁₄B tetragonal compound achieves the improvement of the intrinsic coercive force HcJ. Both of the fine isotropic permanent magnet material and the anisotropic sintered magnet have the RE₂Fe₁₄B tetragonal compound as the main phase, but the main phase size of the anisotropic sintered magnet is about 1 μm to 10 μm, and is equal to or more than the critical single-domain diameter of the RE₂Fe₁₄B tetragonal compound. The anisotropic sintered magnet is in a multi-magnetic domain state before magnetization, and the magnetic moment is aligned in the magnetization direction (C-axis direction) by magnetization to form a single magnetic domain state, thereby exhibiting the permanent magnet properties, and thus the intrinsic coercive force HcJ of the anisotropic sintered magnet represents the ability to maintain a state in which the magnetic moments are aligned in the same direction. Therefore, increasing the anisotropic magnetic field of the RE₂Fe₁₄B tetragonal compound improves the intrinsic coercive force HcJ.

In the low boron-containing concentration and the iron-based rare earth boron-based isotropic nanocomposite magnet alloy of the present disclosure, adding Zr within a certain range allows the metal structure of the magnet alloy to be homogeneously refined, and excellent squareness of a demagnetization curve to be obtained by optimizing exchange coupling acting between particles, and further the compositional composition ratio and metal structure of each phase included in the alloy to be changed, thereby allowing to achieve a specific metal structure having a grain boundary phase including a phase richer in Fe than the main phase, such as Fe₁₇RE₂ and an α-Fe phase. This finding has indicated that it is possible to obtain an isotropic nanocomposite magnet capable of suppressing the decrease in the intrinsic coercive force HcJ of the RE₂Fe₁₄B tetragonal compound, containing the RE₂Fe₁₄B tetragonal compound as a main phase, and containing a ferromagnetic compound, as a sub-phase, including Fe and B including a phase richer in Fe than the main phase. As a result, the iron-based rare earth boron-based isotropic nanocomposite magnet of the present disclosure can provide a high intrinsic coercive force HcJ that could not be achieved by the conventional iron-based rare earth boron-based isotropic magnet without adding heavy rare earths such as Dy and Tb while suppressing a significant decrease in residual magnetic flux density Br.

In addition, the iron-based rare earth boron-based isotropic nanocomposite magnet alloy having a low boron content concentration according to the present disclosure is found to achieve an improvement in the intrinsic coercive force HcJ by substituting carbon (C) for a part of the boron (B) without causing a decrease in the residual magnetic flux density Br, and further, combining substitution of the carbon (C) and addition of a heavy rare earth element can increase an effect of improving the intrinsic coercive force HcJ.

### [Alloy Composition]

The alloy composition of the iron-based rare earth boron-based isotropic nanocomposite magnet alloy of the present disclosure has a formula T_{100-x-y-z}(B₁₋ₙCₙ)ₓRE_{y}Zr_{z}Mₘ (T is at least one element selected from Fe, Co, and Ni, and is a transition metal element including Fe, RE is at least one rare earth element including at least Nd among Nd and Pr, and M is at least one or more metal element selected from Al, Si, V, Cr, Ti, Mn, Cu, Zn, Ga, Nb, Mo, Ag, Hf, Ta, W, Pt, Au, and Pb), where 4.2 atom %≤x≤5.0 atom %, 12.5 atom %≤y≤14.0 atom %, 0 atom %<z≤2.0 atom %, 0.0 atom %≤m≥5.0 atom %, and 0.0≤n≤0.5. The composition of the entire magnet alloy according to the present disclosure is analyzed by ICP mass spectrometry or X-ray fluorescence spectrometry. In addition, a combustion-infrared absorption method may be used in combination as necessary.

The transition metal element T containing Fe as an essential element occupies the content residual of the above-described element. If a part of Fe is substituted with one or two of Co and Ni that are ferromagnetic elements like Fe, desired hard magnetic properties can be obtained. However, if the amount of substitution for Fe is more than 30%, the magnetic flux density is significantly reduced, and thus the amount of substitution is preferably in the range of 0% to 30%. The addition of Co not only contributes to improvement of magnetization, but also has an effect of lowering the viscosity of the molten metal to stabilize the molten metal outflow rate from the nozzle during rapid cooling of the molten metal, and thus the amount of substitution by Co is more preferably 0.5% to 30%, and from the viewpoint of cost effectiveness, the amount of substitution by Co is still more preferably 0.5% to 10%.

In the iron-based rare earth boron-based isotropic nanocomposite magnet alloy of the present disclosure, when the composition ratio x of B+C is less than 4.2 atom %, the amount of B+C required for producing a RE₂Fe₁₄B tetragonal compound cannot be secured, and the magnetic properties are deteriorated and the amorphous forming ability is greatly deteriorated, and thus an α-Fe phase precipitates during molten metal rapid solidification to impair the squareness of the demagnetization curve. In addition, when the composition ratio x of B+C is more than 5.0 atom %, a grain boundary phase containing RE and Fe as a main component and including a phase richer in Fe than the main phase, such as an Fe₁₇RE₂ phase or an α-Fe phase, is not generated, and the intrinsic coercive force HcJ decreases, thus raising a possibility of failing to secure the above-described magnetic properties. Therefore, the composition ratio x is limited to a range of 4.2 atom % to 5.0 atom %. The composition ratio x is preferably 4.4 atom % to 4.9 atom %, and more preferably 4.5 atom % to 4.9 atom %.

In the iron-based rare earth boron-based isotropic nanocomposite magnet alloy of the present disclosure, substituting a part of B with C lowers the melting point of the molten alloy and reduces the amount of wear of the refractory used during rapid solidification, thus not only allowing to reduce the process cost related to rapid solidification, but also allowing to provide the effect of improving the intrinsic coercive force HcJ. However, it is not preferable that the substitution ratio of C for B is more than 50%, because the amorphous forming ability is significantly deteriorated. Therefore, the substitution ratio of C for B is limited to a range of 0% to 50%, that is, 0.0≤n≤0.5. From the viewpoint of the effect of improving the intrinsic coercive force HcJ, the substitution ratio of C for B is preferably 2% to 30%, and more preferably 3% to 15%.

In the iron-based rare earth boron-based isotropic nanocomposite magnet alloy of the present disclosure, when the composition ratio y of at least one rare earth element RE necessarily including at least Nd among Nd and Pr is less than 12.5 atom %, a grain boundary phase containing RE and Fe as main components and including a phase richer in Fe than the main phase, such as an Fe₁₇RE₂ phase or an α-Fe phase, is not generated, raising a possibility of failing to secure the above-described magnetic properties. In addition, when the composition ratio y is more than 14.0 atom %, the magnetization remarkably decreases. Therefore, the composition ratio y is limited to a range of 12.5 atom % to 14.0 atom %. In addition, the composition ratio y is preferably 12.6 atom % to 14.0 atom % from the viewpoint of stably securing the intrinsic coercive force HcJ, and more preferably 12.8 atom % to 13.5 atom % from the viewpoint of securing the high residual magnetic flux density Br.

In addition, the above-described rare earth element RE may be RE_{y}=(Nd₁₋ₗPrₗ)_{y}, and in this case, l is limited to 0.05 to 0.7. When the substitution ratio l of Pr for Nd is too low, the effect of improving HcJ is small, and when l is too high, the absolute value of the temperature coefficient β related to the coercive force of the magnet alloy becomes small, thus causing a concern of deteriorating the heat resistance, and thus l is preferably 0.15 to 0.6, and more preferably 0.2 to 0.5.

In the iron-based rare earth boron-based isotropic nanocomposite magnet alloy of the present disclosure, Zr is an essential additive element for uniform refinement of the magnet alloy and generation of a phase richer in Fe than the main phase of the grain boundary, and when the composition ratio z of Zr is more than 2.0 atom %, magnetization is reduced and a residual magnetic flux density Br of 0.81 T or more cannot be obtained, and thus the composition ratio z is limited to a range of 2.0 atom % or less. In addition, the composition ratio z is preferably 0.6 atom % to 2.0 atom % from the viewpoint of improving the squareness of the demagnetization curve, and more preferably 0.7 atom % to 1.5 atom % from the viewpoint of securing a high residual magnetic flux density Br.

In the iron-based rare earth boron-based isotropic magnet alloy of the present disclosure, one or more metal elements M selected from the group consisting of Al, Si, V, Cr, Ti, Mn, Cu, Zn, Ga, Nb, Mo, Ag, Hf, Ta, W, Pt, Au, and Pb may be added. The addition of the metal element M provides effects such as improvement in the amorphous forming ability, improvement in the intrinsic coercive force HcJ by uniform refinement of the metal structure after the crystallization heat treatment, improvement in the squareness of the demagnetization curve, and the like, and the magnetic properties are improved. However, when the composition ratio m of these metal elements M are more than 5.0 atom %, magnetization is reduced, and thus the composition ratio m is limited to a range of 0.0 atom % to 5.0 atom %. In addition, the composition ratio m is preferably 0.0 atom % to 3.0 atom %, and more preferably 0.0 atom % to 2.0 atom %.

### [Metal Structure]

In the iron-based rare earth boron-based isotropic nanocomposite magnet alloy of the present disclosure, when the average crystal grain size of the RE₂Fe₁₄B tetragonal compound as the main phase is less than 10 nm, the intrinsic coercive force HcJ decreases, and when 70 nm or more, the squareness of the demagnetization curve decreases due to a decrease in exchange interaction acting between crystal grains. Therefore, in order to achieve magnetic properties of a residual magnetic flux density Br of 0.81 T or more, an intrinsic coercive force HcJ of 1200 kA/m to less than 1700 kA/m, and a maximum energy product (BH)max of 110 KJ/m³ or more, the average crystal grain size of the RE₂Fe₁₄B tetragonal compound is limited to a range of 10 nm to less than 70 nm. The average crystal grain size of the RE₂Fe₁₄B tetragonal compound is preferably 15 nm to 60 nm, and more preferably 15 nm to 50 nm.

The average crystal grain size of the RE₂Fe₁₄B tetragonal compound means the average value of the equivalent circle diameters of the particles existing in the field of view when the particle size of each particle is measured at 3 or more points by a line segment method using a transmission electron microscope (TEM).

When there is less than 1 nm the width of the grain boundary phase containing RE and Fe as main components, surrounding the main phase including the RE₂Fe₁₄B tetragonal compound, and including a phase richer in Fe than the main phase, such as the Fe₁₇RE₂ phase and the α-Fe phase, the bonding force acting between the main phase grains increases, leading to a decrease in the intrinsic coercive force HcJ. In addition, when the width of the thickest portion of the grain boundary phase is 150 nm or more, conversely, the interparticle bonding is weakened, and the squareness of the demagnetization curve decreases. Therefore, the width of the thickest portion of the grain boundary phase is not necessarily limited, but is preferably 1 nm to less than 150 nm, more preferably 10 nm to less than 150 nm, more preferably 2 nm to 100 nm, and still more preferably 2 nm to 10 nm. The width of the grain boundary phase was determined by performing image analysis on a bright field image taken using a scanning transmission electron microscope under the conditions of an acceleration voltage of 200 kV and an observation magnification of 900,000 times.

In the iron-based rare earth boron-based isotropic nanocomposite magnet alloy of the present disclosure, in the composition ratio between the main phase and the grain boundary phase, the ratio of the main phase is preferably 70% by volume to less than 99% by volume, and the ratio of the grain boundary phase is preferably 1% by volume to less than 30% by volume. As a result, it is easy to achieve magnetic properties of a residual magnetic flux density Br of 0.81 T or more, an intrinsic coercive force HcJ of 1200 kA/m to less than 1700 kA/m, and a maximum energy product (BH)max of 110 KJ/m³ or more. The ratio of the main phase is preferably 80% by volume to less than 99% by volume, and more preferably 90% by volume to less than 98% by volume. The composition ratio between the main phase and the grain boundary phase was determined by performing image analysis on a bright field image taken using a scanning transmission electron microscope under the conditions of an acceleration voltage of 200 kV and an observation magnification of 900,000 times.

### [Magnetic Properties]

As will be described later, the iron-based rare earth boron-based isotropic nanocomposite magnet alloy of the present disclosure can exhibit an extremely high intrinsic coercive force with an intrinsic coercive force HcJ of 1200 kA/m to less than 1700 kA/m, which has not been able to be achieved as an iron-based rare earth boron-based isotropic magnet alloy, while securing a residual magnetic flux density Br of 0.81 T to a maximum energy product (BH)max of 110 KJ/m³ or more; however, as permanent magnet properties with an intrinsic coercive force HcJ of 1200 kA/m or less of a conventional iron-based rare earth boron-based isotropic magnet, it is difficult for application to various electric motors such as EV and HEV, which require high heat resistance in combination with miniaturization, and therefore, the intrinsic coercive force HcJ is preferably 1200 kA/m or more, more preferably 1250 kA/m or more. When the intrinsic coercive force HcJ is 1700 kA/m or more, magnetization is significantly reduced, and thus the intrinsic coercive force HcJ is preferably 1700 kA/m or less, and more preferably 1600 kA/m or less. In addition, regarding the residual magnetic flux density Br, when an interior permanent magnet rotor (IPM rotor) or the like is adopted, driving is possible at a higher operating point (permeance) than the SPM type, and thus although the residual magnetic flux density Br is preferably as high as possible, in consideration of the balance between heat resistance and the intrinsic coercive force HcJ, the residual magnetic flux density Br is preferably 0.81 T or more, and more preferably 0.82 T or more.

The reason why the residual magnetic flux density Br is set to 0.81 T or more is that, in a case of the application to a DC brushless motor as an isotropic bonded magnet, an operating point (permeance Pc) of the magnet is about 3 to 10, and thus when the residual magnetic flux density Br≥0.81 T, Bm at a level equivalent to the effective magnetic flux Bm at 120° C. in the anisotropic Nd—Fe—B sintered magnet having the maximum energy product (BH)max of 300 KJ/m³ or more can be obtained within the range of the present Pc. The residual magnetic flux density Br is more preferably 0.82 T or more.

In addition, the reason why the intrinsic coercive force HcJ is set to 1200 kA/m or more is that, when the intrinsic coercive force HcJ is less than 1200 kA/m, in the case of application to a DC brushless motor as an isotropic bonded magnet, the heat resistant temperature of the motor cannot be secured to 120° C., raising a possibility of failing to obtain desired motor properties due to thermal demagnetization. In addition, the reason why the intrinsic coercive force HcJ is set to less than 1700 kA/m is that when the intrinsic coercive force HcJ is 1700 kA/m or more, magnetization greatly decreases, and in a magnet specification in which a magnetic path such as polar anisotropic magnetization is long, the magnetic path is not connected, and a necessary effective magnetic flux Bm cannot be obtained.

Further, the reason why the maximum energy product (BH)max is set to 110 KJ/m³ or more is that when the maximum energy product (BH)max is less than 110 KJ/m³, the squareness ratio (residual magnetization Jr/saturation magnetization Js) of the demagnetization curve is 0.8 or less, and thus in a case of application to a DC brushless motor as an isotropic bonded magnet, magnetic properties may be deteriorated due to an inverse magnetic field generated during motor operation, and desired motor properties may not be obtained.

A method for producing an iron-based rare earth boron-based isotropic nanocomposite magnet alloy according to the present disclosure includes: a step of preparing a molten alloy having a composition represented by a composition formula T_{100-x-y-z}(B₁₋ₙCₙ)ₓRE_{y}Zr_{z}Mₘ (T is at least one element selected from the group consisting of Fe, Co, and Ni, and is a transition metal element necessarily including Fe, RE is at least one rare earth element necessarily including at least Nd among Nd and Pr, and M is at least one or more metal element selected from the group consisting of Al, Si, V, Cr, Ti, Mn, Cu, Zn, Ga, Nb, Mo, Ag, Hf, Ta, W, Pt, Au, and Pb), the composition having composition ratios x, y, and z respectively satisfying 4.2 atom %≤x≤5.0 atom %, 12.5 atom %≤y≤14.0 atom %, 0 atom %<z≤2.0 atom %, 0.0 atom %≤m≤5.0 atom %, and 0.0≤n≤0.5; and a step of injecting the molten alloy onto a surface of a rotating roll mainly including Cu, Mo, W or an alloy containing at least one of these metals at an average molten metal outflow rate of 200 g/min to less than 2000 g/min per hole of an orifice disposed at a nozzle tip to form a rapidly solidified alloy having 1% by volume or more of either a crystal phase including a RE₂Fe₁₄B phase or an amorphous phase. RE is at least one rare earth element substantially not including La and Ce, but an example can include at least one rare earth element necessarily including at least Nd among Nd and Pr. Details are as described above.

### [Rapid Cooling of Molten Metal]

In the method for producing an iron-based rare earth boron-based isotropic nanocomposite magnet alloy of the present disclosure, a raw material prepared to have a predetermined alloy composition is dissolved to form a molten alloy, and then the molten alloy is injected onto the surface of a rotating roll containing Cu, Mo, W, or at least one of these metals as main components at an average molten metal outflow rate of 200 g/min to less than 2000 g/min per hole of an orifice disposed at the tip of a nozzle to form a rapidly solidified alloy having 1% by volume or more of either a crystal phase including a RE₂Fe₁₄B phase or an amorphous phase, but when the average molten metal outflow rate is less than 200 g/min, productivity is poor, and, when 2000 g/min or more, a rapidly solidified molten metal alloy structure including a coarse α-Fe phase is obtained, and thus there is a possibility of failing to obtain the above-described magnetic properties if a crystallization heat treatment is performed. Therefore, the average molten metal outflow rate per hole of the orifice disposed at the tip of the nozzle is limited to a range of 200 g/min to less than 2000 g/min. The average molten metal outflow rate is preferably 300 g/min to 1500 g/min, more preferably 400 g/min to 1300 g/min.

The hole disposed at the tip of the nozzle and through which molten metal is discharged is not limited to a circular orifice, but may have a slit shape regardless of the shapes such as a square, a triangle, or an ellipse, as long as the hole has a hole shape that can secure a predetermined molten metal outflow rate. In addition, the nozzle material is acceptable as long as it is a refractory material that does not react with or hardly reacts with the molten alloy, but is preferably a ceramic material, SiC, C, or BN with less wear of the nozzle orifice due to the molten metal in the outflow, more preferably BN, and still more preferably hard BN including an additive.

When the rapidly solidified alloy is formed, an increase in molten metal viscosity can be suppressed by preventing oxidation of the molten alloy, and a stable molten metal outflow rate can be maintained, and thus the rapidly solidified atmosphere is preferably an oxygen-free or low-oxygen atmosphere. In order to achieve this atmosphere, it is necessary to perform rapid cooling and solidification after evacuating the inside of the rapid cooling and solidifying apparatus to 20 Pa or less, preferably 10 Pa or less, and more preferably 1 Pa or less, then introducing an inert gas into the rapid cooling and solidifying apparatus, and setting the oxygen concentration in the rapid cooling and solidifying apparatus to 500 ppm or less, preferably 200 ppm or less, and more preferably 100 ppm or less. As the inert gas, a rare gas such as helium or argon or nitrogen can be used, but nitrogen is relatively easily reacted with a rare earth element and iron, and thus a rare gas such as helium or argon is preferable, and an argon gas is more preferable from the viewpoint of cost.

In the step of forming a rapidly solidified alloy, the rotating roll that rapidly cools the molten alloy contains Cu, Mo, W, or an alloy including at least one of these metals as a main component, and preferably has a substrate including such a main component. This is because these substrates are excellent in thermal conductivity and durability. In addition, plating Cr, Ni, or a combination thereof on the surface of the substrate of the rotating roll can enhance the heat resistance and hardness of the surface of the substrate of the rotating roll, and melting and deterioration of the surface of the substrate of the rotating roll during rapid cooling and solidification can be suppressed. The diameter of the rotating roll is, for example, Φ200 mm to Φ20,000 mm. When the rapid cooling and solidifying time is a short time of 10 sec or less, it is not necessary to cool the rotating roll with water, but when the rapid cooling and solidifying time is more than 10 sec, it is preferable to flow cooling water into the rotating roll to suppress the temperature rise of the rotating roll substrate. The water cooling capacity of the rotating roll is preferably calculated according to the latent heat of solidification and the molten metal outflow rate per unit time, and optimally adjusted as appropriate.

### [Flash Annealing]

The method for producing an iron-based rare earth boron-based isotropic nanocomposite magnet alloy according to the present disclosure further includes a step of subjecting the rapidly solidified alloy to flash annealing of rapid cooling after a lapse of 0.1 sec to less than 7 min after reaching a constant temperature region of a crystallization temperature to 850° C. at a temperature rising rate of 10° C./sec to less than 200° C./sec, and by the step of subjecting to flash annealing, it is preferable to form a metal structure finer than the critical single-domain diameter of the RE₂Fe₁₄B tetragonal compound, in which a grain boundary phase having a width of 1 nm to less than 10 nm and mainly containing RE and Fe including an Fe₁₇RE₂ phase as a main phase and surrounding the main phase while having a B content concentration lower than a stoichiometric composition of the RE₂Fe₁₄B tetragonal compound and having an average crystal grain size of 10 nm to less than 70 nm.

When the temperature rising rate during flash annealing (crystallization heat treatment) is less than 10° C./sec, a fine metal structure cannot be obtained due to excessive grain growth, leading to a decrease in the intrinsic coercive force HcJ and the residual magnetic flux density Br. When the temperature rising rate is 200° C./sec or more, the crystal grain growth cannot be made in time, failing to form a metal structure finer than the critical single-domain diameter of the RE₂Fe₁₄B tetragonal compound in which there is a grain boundary phase containing the RE₂Fe₁₄B tetragonal compound having an average crystal grain size of 10 nm to less than 70 nm necessary for the expression of the permanent magnet as the main phase and a width of 1 nm to less than 10 nm including RE and Fe surrounding the main phase as a main component, and the magnetic properties are deteriorated as in the case of less than 10° C./sec. Therefore, the temperature rising rate is preferably 10° C./sec to less than 200° C./sec, more preferably 30° C./sec to 200° C./sec, and still more preferably 40° C./sec to 180° C./sec.

In the flash annealing (crystallization heat treatment) in the method for producing an iron-based rare earth boron-based isotropic nanocomposite magnet alloy of the present disclosure, in order to obtain favorable magnetic properties, it is preferable to immediately cool the alloy after reaching a crystallization heat treatment temperature (holding temperature) in a constant temperature range of a crystallization temperature to 850° C. More specifically, it is sufficient that the holding time from the crystallization heat treatment temperature to rapid cooling is substantially 0.1 sec or more, and the holding time of 7 min or more is not preferable because uniform and fine metal structures are impaired, leading to deterioration of various magnetic properties. Therefore, the holding time is preferably 0.1 sec to less than 7 min, more preferably 0.1 sec to 2 min, and still more preferably 0.1 sec to 30 sec.

In the flash annealing (crystallization heat treatment) in the method for producing an iron-based rare earth boron-based isotropic nanocomposite magnet alloy of the present disclosure, it is preferable to cool the rapidly solidified alloy to 400° C. or less at a temperature falling rate of 2° C./sec to 200° C./sec. When the temperature falling rate is less than 2° C./sec, coarsening of the crystal structure proceeds, and when the temperature falling rate is more than 200° C./sec, the alloy may be oxidized. Therefore, the temperature falling rate is preferably 2° C./sec to 200° C./sec, more preferably 5° C./sec to 200° C./sec, and still more preferably 5° C./sec to 150° C./sec.

The atmosphere of the flash annealing (crystallization heat treatment) is preferably an inert gas atmosphere in order to prevent oxidation of the rapidly solidified alloy. As the inert gas, a rare gas such as helium or argon or nitrogen can be used, but nitrogen is relatively easily reacted with a rare earth element and iron, and thus a rare gas such as helium or argon is preferable, and an argon gas is more preferable from the viewpoint of cost.

### [Pulverization and Molding]

The method for producing a powder including an iron-based rare earth boron-based isotropic nanocomposite magnet alloy of the present disclosure may further include a step of pulverizing the rapidly solidified alloy or the rapidly solidified alloy subjected to flash annealing to form an iron-based rare earth boron-based isotropic nanocomposite magnet alloy powder.

In the rapidly solidified alloy obtained through the above step, a thin band-shaped rapidly solidified alloy may be roughly cut or pulverized to, for example, 50 mm or less before flash annealing (crystallization heat treatment). Further, forming the magnet alloy of the present disclosure after flash annealing (crystallization heat treatment) into a magnet alloy powder pulverized to an appropriate average powder particle size in a range of an average powder particle size of 20 μm to 200 μm, various resin-bonded permanent magnets (common name: plamag or bonded magnet) can be produced by a known step using the magnet alloy powder.

The method for producing the resin-bonded permanent magnet of the present disclosure can include a step of preparing an iron-based rare earth boron-based isotropic nanocomposite magnet alloy powder produced by the method for producing the iron-based rare earth boron-based isotropic nanocomposite magnet alloy described above; and a step of adding a thermosetting resin to the iron-based rare earth boron-based isotropic nanocomposite magnet alloy powder to be filled into a mold, performing compression molding to form a compression molded body, and then performing a heat treatment at a temperature equal to or more than a polymerization temperature of the thermosetting resin.

The method for producing the resin-bonded permanent magnet of the present disclosure can include a step of preparing an iron-based rare earth boron-based isotropic nanocomposite magnet alloy powder produced by the method for producing the iron-based rare earth boron-based isotropic nanocomposite magnet alloy described above; and a step of adding a thermoplastic resin to the iron-based rare earth boron-based isotropic nanocomposite magnet alloy powder to form an injection molding compound, and then performing injection molding.

When forming the resin-bound permanent magnet, the iron-based rare-earth-based nanocomposite magnet powder is mixed with epoxy, polyamide, polyphenylene sulfide (PPS), a liquid crystal polymer, acrylic, polyether, or the like, and molded into a desired shape. In this case, for example, hybrid magnet powder obtained by mixing permanent magnet powder such as SmFeN-based magnet powder or hard ferrite magnet powder may be used.

It is possible to produce a brushless DC motor requiring compact and heat resistance, such as various electric motors such as EV and HEV, using the above-described resin-bonded permanent magnet.

When the magnet alloy powder of the present disclosure is used for an injection-molded bonded magnet, pulverizing is preferably performed so as to provide the average grain size of 100 μm or less, and the more preferable average crystal grain size of the powder is 20 μm to 100 μm. In addition, in a case of use for a compression-molded bonded magnet, pulverizing is preferably performed so as to provide an average grain size of 200 μm or less, and more preferable average crystal grain size of the powder is 50 μm to 150 μm. More preferably, there are two peaks in the particle size distribution, and the average crystal grain size is 80 μm to 130 μm.

Subjecting the surface of the magnet alloy powder of the present disclosure to a surface treatment such as a coupling treatment or a chemical conversion treatment (including a phosphoric acid treatment and a glass film treatment) can improve the moldability during molding the resin-bonded permanent magnet and the corrosion resistance and heat resistance of the obtained resin-bonded permanent magnet regardless of the molding method. In addition, when the surface of the resin-bonded permanent magnet after molding is subjected to surface treatment such as resin coating, chemical conversion treatment, or plating, it is possible to improve the corrosion resistance and heat resistance of the resin-bonded permanent magnet similarly to the surface treatment of the magnet alloy powder.

The method for producing the iron-based rare earth boron-based isotropic nanocomposite magnet alloy of the present disclosure is not limited to the above-described method, and other production methods can be adopted as long as the iron-based rare earth boron-based isotropic magnet alloy having the above-described composition, average crystal grain size, and the like can be produced. For example, when flash annealing is used, it is possible to form a fine metal structure having a RE₂Fe₁₄B tetragonal compound having an average crystal grain size of 10 nm to less than 70 nm as a main phase, but in order to form such a fine metal structure, the method is not limited to the flash annealing, and other methods can be adopted. For example, when adopting a normal annealing step instead of flash annealing, the surface speed of the rotating roll for rapidly cooling the molten alloy is adjusted to form a rapidly solidified alloy structure as a homogeneous fine metal structure including crystal grains about 5% to 20% smaller than the alloy structure that provides optimal magnetic properties, thereby allowing favorable magnetic properties to be obtained.

### EXAMPLES

Hereinafter, embodiments of the present disclosure will be described. The present disclosure is not limited only to these examples.

### Examples

100 g of an element raw material in which an additive element such as Si, Ti, Cu, Zn, Ga, Nb, or Hf was blended in addition to main elements such as Nd, Pr, B, Co, C, Zr, and Fe having a purity of 99.5% or more was charged into an alumina melting crucible so as to provide an alloy composition described in Table 1, and then set in a work coil in a vacuum melting furnace. Then, the inside of the vacuum melting furnace was evacuated to 0.02 Pa or less, argon gas was introduced to normal pressure, and then a molten alloy was formed by high frequency induction heating. Thereafter, the molten alloy was cast into a water-cooled copper mold to form a mother alloy.

Subsequently, the obtained mother alloy was divided into an appropriate size, and then 40 g thereof was inserted into a transparent quartz nozzle having an orifice having an appropriate diameter (0.7 mm to 1.2 mm) so as to provide an average molten metal outflow rate (In Table 1, “molten metal outflow rate” was simply shown) described in Table 1 at the bottom, and then the mother alloy was set in a work coil in a single roll rapid cooling apparatus. Then, the inside of the vacuum melting furnace was evacuated to 0.02 Pa or less, argon gas was then introduced until the rapidly cooling atmospheric pressure described in Table 1 was reached, the mother alloy was redissolved by high-frequency induction heating, and the molten alloy was outflowed from the nozzle orifice at an injection pressure of 30 kPa onto the surface of the rotating roll rotating at the roll surface speed (Vs) described in Table 1 to form a rapidly solidified alloy. In this case, the distance between the tip of the nozzle and the surface of the rotating roll was set to 0.8 mm. In addition, the main component of the rotating roll was copper. In addition, the obtained rapidly solidified alloy had 1% by volume or more of either the crystal phase including the Nd₂Fe₁₄B phase or the amorphous phase.

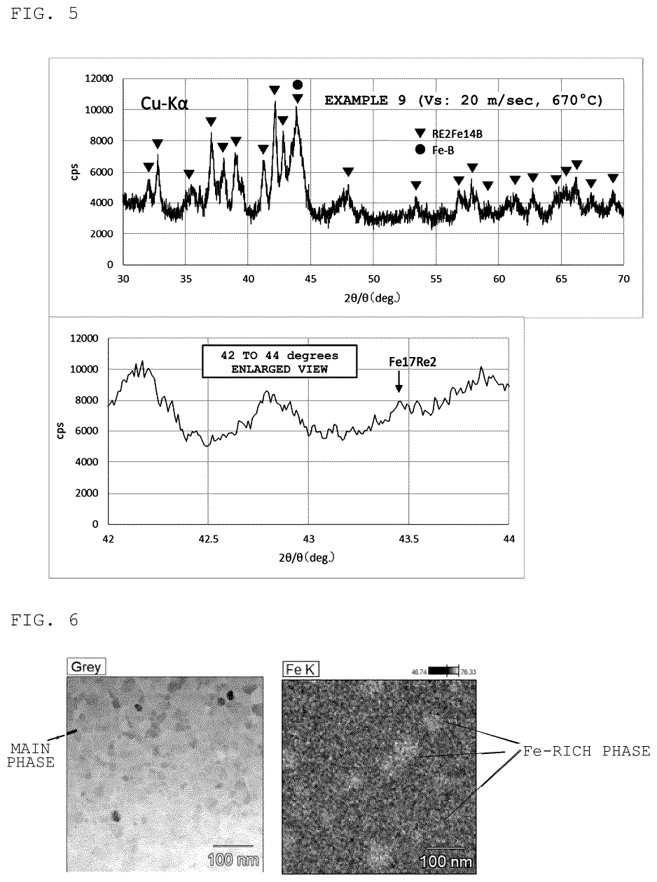

As a representative example, FIG. 4 shows a powder X-ray diffraction profile of the rapidly solidified alloy obtained in Example 9. From FIG. 4, the presence of the Nd₂Fe₁₄B phase was already confirmed in a rapidly solidified state.

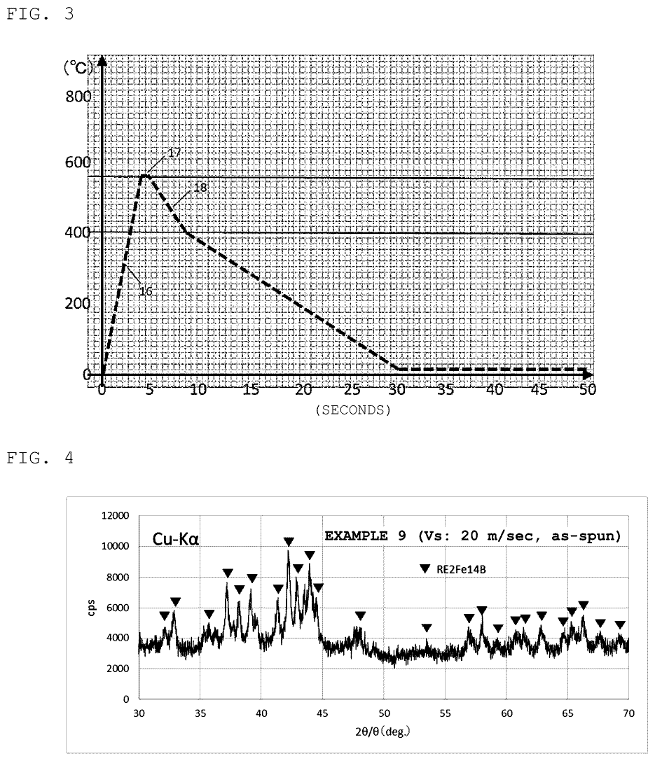

The rapidly solidified alloy obtained in the above step was coarsely pulverized to several mm or less to form a rapidly solidified alloy powder, and then the coarse powder of the rapidly solidified alloy was charged into a raw material hopper using a flash annealing furnace (crystallization heat treatment furnace, furnace core tube: made of transparent quartz and having an outer diameter of 15 mm×an inner diameter of 12.5 mm×a length of 1000 mm, a heating zone of 300 mm, and a cooling zone of 500 mm by a cooling fan), and then heat treatment was performed at a workpiece cutting speed of 20 g/min. The furnace core tube tilt angle, the furnace core tube rotation speed, and the furnace core tube vibration frequency were appropriately adjusted together with the heat treatment temperature and the heat treatment time described in Table 2 so as to achieve the temperature rising rate described in Table 2. As a result, the rapidly solidified alloy powder passed through the furnace core tube while performing a movement in which stirring by the furnace core tube rotational movement and a hopping phenomenon by the furnace core tube vibration were combined, whereby the rapidly solidified alloy powder underwent a specific heat treatment condition in which powder particles received a thermal history not integrally but individually. An example of the heat treatment furnace and the thermal history in the step of performing the flash annealing is shown in FIGS. 2 and 3, respectively.

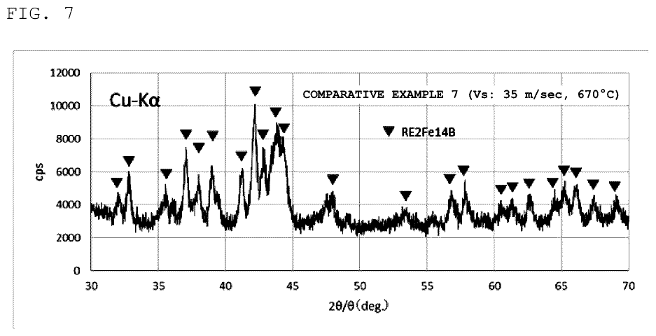

The constituent phases of the rapidly solidified alloy powder after the flash annealing (crystallization heat treatment) were confirmed by powder X-ray diffraction, and the presence of the Nd₂Fe₁₄B phase and the Fe₁₇RE₂ phase was confirmed. FIG. 5 shows, as a representative example, a powder X-ray diffraction profile of the rapidly solidified alloy after flash annealing (crystallization heat treatment) obtained in Example 9. In addition, the peak of the Fe₁₇RE₂ phase, which was not observed in FIG. 4, was observed in FIG. 5 after flash annealing (crystallization heat treatment), and was confirmed to be the composite structure mixed with the Nd₂Fe₁₄B phase and the Fe₁₇RE₂ phase. In addition, element mapping using TEM-EDX on the rapidly solidified alloy after flash annealing (crystallization heat treatment) obtained in Example 24 confirmed the presence of a phase richer in Fe than the main phase. As a representative example, FIG. 6 shows an element mapping image obtained in Example 24. The left image of FIG. 6 is a bright field image of STEM, and the main phase and the grain boundary phase can be visually recognized. On the other hand, the right image in FIG. 6 is a mapping image of Fe, and Fe is confirmed to be rich at a position corresponding to the grain boundary phase in the left image.

A bright field image element mapping obtained by observing the rapidly solidified alloy subjected to flash annealing (crystallization heat treatment) with a transmission electron microscope confirmed the presence of an Nd₂Fe₁₄B phase having an average crystal grain size of 50 nm or less and a clear grain boundary phase surrounding the Nd₂Fe₁₄B phase. In addition, in the element mapping, the grain boundary phase with Nd and Fe concentrated can be confirmed to be present at the crystal grain boundary of the main phase including the main constituent elements of Nd, Fe, and B, and is presumed to be present at the grain boundary including the Fe₁₇RE₂ phase and including Fe and RE based on the results of the powder X-ray diffraction described above. It has been confirmed by the present inventors that the grain boundary phase including the Fe₁₇RE₂ phase and containing Fe and RE is formed in all Examples. In addition, in all the examples, the width of the thickest portion of the grain boundary phase was 1 nm to less than 150 nm. For example, in the grain boundary phase observed in Example 24, although various thicknesses were mixed, the width of the thickest portion was 2 nm to 117 nm. In addition, in all the examples, for the composition ratio between the main phase and the grain boundary phase, the ratio of the main phase was 70% by volume to less than 99% by volume, and the ratio of the grain boundary phase was 1% by volume to less than 30% by volume. For example, in Example 1, for the composition ratio between the main phase and the grain boundary phase, the ratio of the grain boundary phase was 18% by volume, and the ratio of the main phase was 82% by volume.

The iron-based rare earth boron-based isotropic magnet alloy obtained by performing the flash annealing (crystallization heat treatment) described in Table 2 was made into a sample for evaluation of magnetic properties having a length of about 7 mm×a width of about 0.9 mm to 2.3 mm×a thickness of 18 μm to 25 μm, and then magnetized in the longitudinal direction by a pulse-applied magnetic field of 3.2 MA/m. Thereafter, the sample for evaluation of magnetic properties was set in the longitudinal direction in order to suppress the influence of the diamagnetic field, and the results of measuring the room temperature magnetic properties with a vibrating sample magnetometer (VSM) are shown in Table 3. From Table 3, magnetic properties of the above-described residual magnetic flux density Br: 0.81 T or more, intrinsic coercive force HcJ: 1200 kA/m to less than 1700 kA/m, and maximum energy product (BH)max: 110 KJ/m³ or more were found to be obtained by the alloy composition and production method described in Examples 1 to 24.

Then, the magnetic powder subjected to flash annealing (crystallization heat treatment) obtained in Example 9 was pulverized with a pin disc mill so as to have an average particle size of 125 μm. Then, 2% by mass of an epoxy resin diluted with methyl ethyl ketone (MEK) was added to the pulverized magnetic powder, the mixture was mixed and kneaded, and then 0.1% by mass of calcium stearate was added thereto as a lubricant to form a compound for a compression-molded bonded magnet.

The above compound for a compression-molded bonded magnet was compression-molded at a pressure of 1568 MPa (16 ton/cm²) to provide a compression molded body having a shape of a diameter of 10 mm×a height of 7 mm, and then this compression molded body was subjected to a curing heat treatment (curing) at 180° C. for 1 hour in an argon gas atmosphere to provide an isotropic compression-molded bonded magnet. The obtained isotropic compression-molded bonded magnet had a molded body density of 6.3 g/cm³ (true specific gravity of magnetic powder, 7.5 g/cm³), and thus the magnetic powder filling ratio was 84% by volume.

The magnetic properties of the isotropic compression-molded bonded magnet obtained using the magnetic powder of Example 9 were measured by a BH tracer after being magnetized in the longitudinal direction with a pulse-applied magnetic field of 3.2 MA/m, and it was found that magnetic properties of residual magnetic flux density Br: 0.71 T, intrinsic coercive force HcJ: 1223 kA/m, and maximum energy product (BH)max: 82.2 KJ/m³ were exhibited.

Then, the magnetic powder subjected to flash annealing (crystallization heat treatment) obtained in Example 9 was pulverized with a pin disc mill so as to have an average particle size of 75 μm. While the pulverized magnetic powder was heated and stirred, a titanate-based coupling agent was sprayed so as to be 0.75% by mass, and subjected to a coupling treatment, 0.5% by mass of stearic acid amide as a lubricant and 4.75% by mass of nylon 12 resin powder were added and mixed, and then a compound for an injection-molded bonded magnet was formed at an extrusion temperature of 170° C. using a continuous extrusion kneader.

Using the above compound for an injection-molded bonded magnet, injection molding was performed at an injection temperature of 250° C. to form an isotropic injection-molded bonded magnet having a shape of 10 mm in diameter×7 mm in height. The obtained isotropic injection-molded bonded magnet had a molded body density of 4.6 g/cm³ (true specific gravity of magnetic powder, 7.5 g/cm³), and thus the magnetic powder filling ratio was 61% by volume.

The magnetic properties of the isotropic injection-molded bonded magnet obtained using the magnetic powder of Example 9 were measured by a BH tracer after being magnetized in the longitudinal direction with a pulse-applied magnetic field of 3.2 MA/m, and as a result, it was found that magnetic properties of residual magnetic flux density Br: 0.51 T, intrinsic coercive force HcJ: 1218 kA/m, and maximum energy product (BH)max: 60.1 KJ/m³ were exhibited, and magnetic properties equivalent to those of a general isotropic Nd—Fe—B compression-molded bonded magnet were obtained by injection molding.

### Comparative Example

100 g of an element raw material in which an additive element such as Co and Nb was blended in addition to main elements such as Nd, Pr, Dy, B, and Fe having a purity of 99.5% or more was charged into an alumina melting crucible so as to provide an alloy composition described in Table 1, and then set in a work coil in a vacuum melting furnace. Then, the inside of the vacuum melting furnace was evacuated to 0.02 Pa or less, argon gas was introduced to normal pressure, and then a molten alloy was formed by high frequency induction heating. Thereafter, the molten alloy was cast into a water-cooled copper mold to form a mother alloy.

Subsequently, the obtained mother alloy was divided into an appropriate size, and then 40 g thereof was inserted into a transparent quartz nozzle having an orifice having an appropriate diameter (0.7 mm to 1.2 mm) so as to provide an average molten metal outflow rate (In Table 1, “molten metal outflow rate” was simply shown) described in Table 1 at the bottom, and then the mother alloy was set in a work coil in a single roll rapid cooling apparatus. Then, the inside of the vacuum melting furnace was evacuated to 0.02 Pa or less, argon gas was then introduced until the rapidly cooling atmospheric pressure described in Table 1 was reached, the mother alloy was redissolved by high-frequency induction heating, and the molten alloy was outflowed from the nozzle orifice at an injection pressure of 30 kPa onto the surface of the rotating roll rotating at the roll surface speed (Vs) described in Table 1 to form a rapidly solidified alloy. In this case, the distance between the tip of the nozzle and the surface of the rotating roll was set to 0.8 mm.

The rapidly solidified alloy obtained in the above step was coarsely pulverized to several mm or less to form a rapidly solidified alloy powder, and then the coarse powder of the rapidly solidified alloy was charged into a raw material hopper using a flash annealing furnace (crystallization heat treatment furnace, furnace core tube: made of transparent quartz and having an outer diameter of 15 mm×an inner diameter of 12.5 mm×a length of 1000 mm, a heating zone of 300 mm, and a cooling zone of 500 mm by a cooling fan), and then heat treatment was performed at a workpiece cutting speed of 20 g/min. The furnace core tube tilt angle, the furnace core tube rotation speed, and the furnace core tube vibration frequency were appropriately adjusted together with the heat treatment temperature and the heat treatment time described in Table 2 so as to achieve the temperature rising rate described in Table 2.

The constituent phases of the rapidly solidified alloy powder after the flash annealing (crystallization heat treatment) were confirmed by powder X-ray diffraction, and the presence of the Nd₂Fe₁₄B phase was confirmed. FIG. 7 shows, as a representative example, a powder X-ray diffraction profile of the rapidly solidified alloy after flash annealing (crystallization heat treatment) obtained in Comparative Example 7. From FIG. 7, it was confirmed that Comparative Example 7 had a single-phase metal structure having the Nd₂Fe₁₄B phase as a main phase.

According to a bright field image and element mapping obtained by observing the iron-based rare earth boron-based isotropic magnet alloy obtained in Comparative Example 7 with a transmission electron microscope, in the bright field image, an Nd₂Fe₁₄B phase having an average crystal grain size of 50 nm or less could be confirmed, but a clear grain boundary phase could not be confirmed. In addition, from the element mapping, it was found that the grain boundary phase in which Fe and RE were concentrated as seen in Example 9 was not present at the crystal grain boundary of the main phase composed of the main constituent elements of Nd, Fe, and B. The same applies to the other comparative examples.

The iron-based rare earth boron-based isotropic magnet alloy obtained by performing the flash annealing (crystallization heat treatment) described in Table 2 was made into a sample for evaluation of magnetic properties having a length of about 7 mm×a width of about 0.9 mm to 2.3 mm×a thickness of 18 μm to 25 μm, and then magnetized in the longitudinal direction by a pulse-applied magnetic field of 3.2 MA/m. Thereafter, the sample for evaluation of magnetic properties was set in the longitudinal direction in order to suppress the influence of the diamagnetic field, and the results of measuring the room temperature magnetic properties with a vibrating sample magnetometer (VSM) are shown in Table 3. From Table 3, it was found that the above-described magnetic properties of Br: 0.81 T or more, HcJ: 1200 kA/m to less than 1700 kA/m, and (BH)max: 110 KJ/m³ or more were not obtained from the alloy composition and the production method described in Comparative Examples 1 to 12.

In general, the residual magnetic flux density Br and the intrinsic coercive force HcJ are in a trade-off relationship, and it is difficult to achieve both a high residual magnetic flux density Br and a high intrinsic coercive force HcJ. In contrast, in the present Example, having the Fe-rich grain boundary phase in which the width of the thickest portion of the grain boundary phase is 1 nm to less than 150 nm as described above, the exchange interaction effectively works between the main phase and the grain boundary phase, and both properties can be improved. For example, Example 11 and Comparative Example 5 have substantially the same high intrinsic coercive force HcJ, but Example 11 achieves a higher residual magnetic flux density Br than Comparative Example 5.

TABLE 1

| | | | Rapid cooling | Molten | Roll |
|---|---|---|---|---|---|
| | | | atmospheric | metal | surface |
| | | | pressure | outflow | speed |
| | | Alloy composition (atom %) | (kPa) | rate | (m/sec) |
| Example | 1 | Nd12.6Fe81.5B4.9Zr1 | 61.3 | 430 | 20 |
| | 2 | Nd7.55Pr5.03Fe81.52B4.9Zr1 | 41.3 | 430 | 24 |
| | 3 | Nd7.55Pr5.03Fe81.72B4.7Zr1 | 41.3 | 430 | 20 |
| | 4 | Nd7.57Pr5.05Fe81.78B4.6Zr1 | 31.3 | 510 | 20 |
| | 5 | Nd7.6Pr5.06Fe81.54B4.8Zr1 | 41.3 | 510 | 24 |
| | 6 | Nd8.17Pr5.45Fe78.58Co2B4.8Zr1 | 81.3 | 340 | 24 |
| | 7 | Nd7.88Pr5.26Fe80.96B4.9Zr1 | 31.3 | 430 | 19 |
| | 8 | Nd7.88Pr5.26Fe81.36B4.5Zr1 | 41.3 | 430 | 20 |
| | 9 | Nd7.88Pr5.26Fe81.21B4.65Zr1 | 41.3 | 430 | 20 |
| | 10 | Nd7.88Pr5.26Fe81.01B4.65Zr1.2 | 41.3 | 600 | 20 |
| | 11 | Nd7.88Pr5.26Fe76.41Co5B4.65Zr0.8 | 21.3 | 520 | 20 |
| | 12 | Nd7.88Pr5.26Fe81.61B4.65Zr0.6 | 41.3 | 770 | 20 |
| | 13 | Nd7.88Pr5.26Fe81.56B3.3C1Zr1 | 21.3 | 770 | 30 |
| | 14 | Nd7.88Pr5.26Fe81.21B3.4C1.25Zr1 | 41.3 | 770 | 23 |
| | 15 | Nd7.88Pr5.26Fe80.71B4.65Zr1.5 | 41.3 | 930 | 18 |
| | 16 | Nd7.88Pr5.26Fe80.21B4.65Zr2 | 41.3 | 1240 | 20 |
| | 17 | Nd7.88Pr5.26Fe81.91B4.65Zr0.8Si0.5 | 41.3 | 600 | 20 |
| | 18 | Nd7.88Pr5.26Fe81.91B4.65Zr0.8Cu0.5 | 41.3 | 600 | 20 |
| | 19 | Nd7.88Pr5.26Fe81.91B4.65Zr0.8Ga0.5 | 41.3 | 600 | 20 |
| | 20 | Nd7.88Pr5.26Fe81.21B4.65Zr0.5Nb0.5 | 41.3 | 430 | 17 |
| | 21 | Nd7.88Pr5.26Fe80.21B4.65Zr1Ti1 | 41.3 | 430 | 23 |
| | 22 | Nd7.88Pr5.26Fe80.21B4.65Zr1Hf1 | 41.3 | 860 | 23 |
| | 23 | Nd7.88Pr5.26Fe81.21B4.65Zr0.5Zn0.5 | 41.3 | 430 | 27 |
| | 24 | Nd7.70Pr5.16Fe82.54B4.6Zr0.001 | 31.3 | 510 | 20 |
| Comparative | 1 | Nd12Fe82B6 | 101.3 | 600 | 30 |
| Example | 2 | Nd12Fe82B6 | 41.3 | 600 | 30 |
| | 3 | Nd12Fe81B6Si1 | 41.3 | 600 | 25 |
| | 4 | Nd11.6Dy0.4Fe82B6 | 31.3 | 600 | 25 |
| | 5 | Nd14Fe80B6 | 41.3 | 600 | 30 |
| | 6 | Nd12Fe80Co2B6 | 41.3 | 600 | 30 |
| | 7 | Nd11.7Fe80.5B6.5Nb1.3 | 21.3 | 860 | 35 |
| | 8 | Nd9Fe84.5B5.5Ti1 | 21.3 | 600 | 30 |
| | 9 | Nd10.5Fe83B6Ti0.5 | 41.3 | 600 | 35 |
| | 10 | Nd10Fe81B9 | 41.3 | 860 | 25 |
| | 11 | Nd9F80B7Ti1Zr3 | 61.3 | 430 | 12 |
| | 12 | Nd4B77.518.5 | 41.3 | 2150 | 10 |

TABLE 2

| | | Temperature | Heat treatment | Heat treatment |
|---|---|---|---|---|
| | | rising rate | temperature | time |
| | | (° C./sec) | (° C.) | (sec) |
| Example | 1 | 120 | 670 | 5 |
| | 2 | 120 | 680 | 5 |
| | 3 | 125 | 690 | 5 |
| | 4 | 120 | 680 | 5 |
| | 5 | 130 | 689 | 5 |
| | 6 | 130 | 670 | 5 |
| | 7 | 120 | 660 | 5 |
| | 8 | 130 | 670 | 5 |
| | 9 | 130 | 670 | 5 |
| | 10 | 130 | 680 | 5 |
| | 11 | 125 | 670 | 5 |
| | 12 | 125 | 670 | 5 |
| | 13 | 125 | 660 | 5 |
| | 14 | 125 | 670 | 5 |
| | 15 | 130 | 670 | 5 |
| | 16 | 70 | 680 | 10 |
| | 17 | 130 | 670 | 5 |
| | 18 | 140 | 670 | 5 |
| | 19 | 130 | 660 | 5 |
| | 20 | 70 | 670 | 10 |
| | 21 | 125 | 680 | 5 |
| | 22 | 130 | 670 | 5 |
| | 23 | 165 | 670 | 4 |
| | 24 | 200 | 640 | 15 |
| Comparative | 1 | 4 | 660 | 180 |
| Example | 2 | 60 | 670 | 10 |
| | 3 | 60 | 650 | 10 |
| | 4 | 130 | 660 | 5 |
| | 5 | 70 | 680 | 10 |
| | 6 | 130 | 660 | 5 |
| | 7 | 140 | 680 | 5 |
| | 8 | 80 | 735 | 10 |
| | 9 | 70 | 690 | 10 |
| | 10 | 140 | 679 | 5 |
| | 11 | 70 | 680 | 10 |
| | 12 | 60 | 620 | 10 |

TABLE 3

| | | Magnetic properties | | |
|---|---|---|---|---|
| | | Br | HcJ | (BH)max |
| | | (T) | (kA/m) | (KJ/m3) |
| Example | 1 | 0.83 | 1327.0 | 114.9 |
| | 2 | 0.82 | 1513.7 | 111.6 |
| | 3 | 0.85 | 1202.5 | 120.2 |
| | 4 | 0.83 | 1209.7 | 111.5 |
| | 5 | 0.83 | 1335.8 | 116.0 |
| | 6 | 0.84 | 1643.8 | 118.2 |
| | 7 | 0.83 | 1201.0 | 116.2 |
| | 8 | 0.83 | 1257.5 | 113.5 |
| | 9 | 0.84 | 1235.8 | 120.4 |
| | 10 | 0.82 | 1223.3 | 111.5 |
| | 11 | 0.85 | 1269.2 | 123.9 |
| | 12 | 0.81 | 1329.5 | 111.4 |
| | 13 | 0.84 | 1204.4 | 111.7 |
| | 14 | 0.83 | 1242.7 | 118.3 |
| | 15 | 0.81 | 1282.9 | 112.5 |
| | 16 | 0.81 | 1315.2 | 114.8 |
| | 17 | 0.81 | 1248.1 | 113.4 |
| | 18 | 0.81 | 1270.6 | 112.3 |
| | 19 | 0.82 | 1233.7 | 115.1 |
| | 20 | 0.81 | 1305.4 | 113.7 |
| | 21 | 0.81 | 1272.2 | 115.3 |
| | 22 | 0.81 | 1249.1 | 110.4 |
| | 23 | 0.82 | 1210.3 | 114.1 |
| | 24 | 0.82 | 1200.6 | 111.1 |
| Comparative | 1 | 0.82 | 735.6 | 110.8 |
| Example | 2 | 0.84 | 751.5 | 118.3 |
| | 3 | 0.84 | 700.7 | 122.1 |
| | 4 | 0.82 | 873.5 | 119.3 |
| | 5 | 0.80 | 1250.8 | 111.4 |
| | 6 | 0.85 | 723.1 | 123.6 |
| | 7 | 0.84 | 978.3 | 120.2 |
| | 8 | 0.92 | 569.4 | 121.1 |
| | 9 | 0.92 | 628.8 | 124.5 |
| | 10 | 0.93 | 558.2 | 123.7 |
| | 11 | 0.89 | 664.5 | 124.8 |
| | 12 | 0.88 | 410.6 | 116.3 |

### DESCRIPTION OF REFERENCE SYMBOLS

1: Raw material hopper
2: Raw material feeder
3: Furnace core tube
3a: Enlarged view of furnace core tube
3b: Enlarged view of furnace core tube sectional
4: Tubular furnace
5: Cooling tower
6: Raw material hopper
7: Vibrator
8: Rotating motor of furnace core tube
9: Rotation axis of furnace core tube
10: Apparatus frame
11: Inclination angle of furnace core tube
12: Cooling fan air
13: Rapidly solidified alloy powder (workpiece)
14: Moving direction of workpiece
15: Hopping phenomenon of workpiece
16: Temperature rising rate
17: Holding temperature
18: Temperature falling rate
21: Main phase
22: Grain boundary phase

1. An iron-based rare earth boron-based isotropic nanocomposite magnet alloy comprising:
an alloy composition having a formula T_{100-x-y-z}(B₁₋ₙCₙ)ₓRE_{y}Zr_{z}Mₘ where T is at least one element selected from Fe, Co, and Ni, and is a transition metal element including Fe, RE is at least one rare earth element including at least Nd among Nd and Pr, and M is at least one or more metal element selected from Al, Si, V, Cr, Ti, Mn, Cu, Zn, Ga, Nb, Mo, Ag, Hf, Ta, W, Pt, Au, and Pb, wherein:
4.2 atom %≤x≤5.0 atom %,
13.1 atom %≤y≤14.0 atom %,
0 atom %<z≤2.0 atom %,
0.5 atom %≤m≤5.0 atom %, and
0.0≤n≤0.5; and
the iron-based rare earth boron-based isotropic nanocomposite magnet alloy including a main phase having a RE₂Fe₁₄B tetragonal compound with a B content concentration lower than a stoichiometric composition of the RE₂Fe₁₄B tetragonal compound, and a grain boundary phase comprising a phase richer in Fe than the main phase surrounding the main phase, and the RE₂Fe₁₄B tetragonal compound is finer than a critical single-domain diameter of an average crystal grain size of 10 nm to less than 70 nm.

2. The iron-based rare earth boron-based isotropic nanocomposite magnet alloy according to claim 1, wherein a width of a thickest portion of the grain boundary phase is 1 nm to less than 150 nm.

3. The iron-based rare earth boron-based isotropic nanocomposite magnet alloy according to claim 1, wherein a width of a thickest portion of the grain boundary phase is 10 nm to less than 150 nm.

4. The iron-based rare earth boron-based isotropic nanocomposite magnet alloy according to claim 1, wherein in a composition ratio between the main phase and the grain boundary phase, a ratio of the main phase is 70% by volume to less than 99% by volume, and a ratio of the grain boundary phase is 1% by volume to less than 30% by volume.

5. The iron-based rare earth boron-based isotropic nanocomposite magnet alloy according to claim 1, wherein the iron-based rare earth boron-based isotropic nanocomposite magnet alloy has a residual magnetic flux density Br of 0.81 T or more, an intrinsic coercive force HcJ of 1200 kA/m to less than 1700 kA/m, and a maximum energy product (BH)max of 110 KJ/m³ or more.

6. The iron-based rare earth boron-based isotropic nanocomposite magnet alloy according to claim 1, wherein the RE includes at least Nd and Pr.

7. The iron-based rare earth boron-based isotropic nanocomposite magnet alloy according to claim 1, wherein, in the T, 0% to 30% of the Fe is substituted with one or both of Co and Ni.

8. A method for producing an iron-based rare earth boron-based isotropic nanocomposite magnet alloy, the method comprising:
preparing a molten alloy having a composition represented by a formula T_{100-x-y-z}(B₁₋ₙCₙ)ₓRE_{y}Zr_{z}Mₘ where T is at least one element selected from Fe, Co, and Ni, and is a transition metal element including Fe, RE is at least one rare earth element including at least Nd among Nd and Pr, and M is at least one or more metal element selected from Al, Si, V, Cr, Ti, Mn, Cu, Zn, Ga, Nb, Mo, Ag, Hf, Ta, W, Pt, Au, and Pb, wherein:
4.2 atom %≤x≤5.0 atom %,
13.1 atom %≤y≤14.0 atom %,
0 atom %<z≤2.0 atom %,
0.0 atom %≤m≤5.0 atom %, and
0.0≤n≤0.5; and
injecting the molten alloy onto a surface of a rotating roll mainly including Cu, Mo, W or an alloy containing at least one of Cu, Mo, and W at an average molten metal outflow rate of 200 g/min to less than 2000 g/min per hole of an orifice disposed at a nozzle tip to form a solidified alloy having 1% by volume or more of either a crystal phase including a RE₂Fe₁₄B phase or an amorphous phase.

9. The method for producing an iron-based rare earth boron-based isotropic nanocomposite magnet alloy according to claim 8, further comprising: subjecting the solidified alloy to flash annealing of cooling after a lapse of 0.1 sec to less than 7 min after reaching a constant temperature region of a crystallization temperature to 850° C. at a temperature rising rate of 10° C./sec to less than 200° C./sec, so as to form a nanocomposite metal structure by performing the flash annealing, the nanocomposite metal structure including a main phase having a RE₂Fe₁₄B tetragonal compound with a B content concentration lower than a stoichiometric composition of the RE₂Fe₁₄B tetragonal compound, and a grain boundary phase comprising a phase richer in Fe than the main phase surrounding the main phase, and the RE₂Fe₁₄B tetragonal compound is finer than a critical single-domain diameter of an average crystal grain size of 10 nm to less than 70 nm.

10. A method for producing a powder, the method comprising:
preparing the iron-based rare earth boron-based isotropic nanocomposite magnet alloy according to claim 8; and
forming an iron-based rare earth boron-based isotropic magnet alloy powder by pulverizing the solidified alloy.

11. A method for producing a powder, the method comprising:
preparing the iron-based rare earth boron-based isotropic nanocomposite magnet alloy according to claim 9; and
forming an iron-based rare earth boron-based isotropic magnet alloy powder by pulverizing the solidified alloy subjected to the flash annealing.

12. A method for producing a resin-bonded permanent magnet, the method comprising:
preparing the powder according to claim 10; and
adding a thermosetting resin to the iron-based rare earth boron-based isotropic nanocomposite magnet alloy powder to form a mixture;
compression molding the mixture to form a compression molded body; and
performing a heat treatment at a temperature equal to or more than a polymerization temperature of the thermosetting resin.

13. A method for producing a resin-bonded permanent magnet, the method comprising:
preparing the powder according to claim 11; and
adding a thermosetting resin to the iron-based rare earth boron-based isotropic nanocomposite magnet alloy powder to form a mixture;
compression molding the mixture to form a compression molded body; and
performing a heat treatment at a temperature equal to or more than a polymerization temperature of the thermosetting resin.

14. A method for producing a resin-bonded permanent magnet, the method comprising:
preparing the powder according to claim 10;
adding a thermoplastic resin to the iron-based rare earth boron-based isotropic nanocomposite magnet alloy powder to form an injection molding compound; and
performing injection molding using the injection molding compound.

15. A method for producing a resin-bonded permanent magnet, the method comprising:
preparing the powder according to claim 11;
adding a thermoplastic resin to the iron-based rare earth boron-based isotropic nanocomposite magnet alloy powder to form an injection molding compound; and
performing injection molding using the injection molding compound.
